(19) United States
(12) Patent Application Publication
(10) Pub. No.: US 2012/0278416 A1
(43) Pub. Date: Nov. 1, 2012

(54) METHODS, APPARATUSES AND COMPUTER PROGRAM PRODUCT FOR USING BEARER MANAGEMENT INFORMATION TO REDUCE TRAFFIC WITHIN A COMMUNICATIONS NETWORK

(75) Inventor: Tuija Helena Hurtta, Espoo (FI)

(73) Assignee: NOKIA SIEMENS NETWORKS OY, Espoo (FI)

(21) Appl. No.: 13/519,969

(22) PCT Filed: Dec. 31, 2009
(86) PCT No.: PCT/EP2009/068044

§ 371 Date: Jun. 29, 2012

(51) Int. Cl. G06F 15/16

(52) U.S. Cl. 709/206

(57) ABSTRACT

According to an exemplary embodiment of the present invention a method may be provided, which method may comprise receiving a first message comprising a bearer management information for a session of a user, selecting a first network device wherein the selected first network device may be located in a down-stream direction towards the user and sending a second message comprising the bearer management information to the selected network device.

### TECHNICAL FIELD

Embodiments of the present invention relate generally to mobile communications and more particularly to network devices and methods in communications networks. Moreover, the invention relates to a communication system, to a computer program product and to a computer-readable medium.

### BACKGROUND

The modern communications era has brought about a tremendous expansion of wireline and wireless networks. Various types of networking technologies have been developed resulting in unprecedented expansion of computer networks, television networks, telephony networks, and the like, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices and other computing devices. The functionality of mobile communications devices continues to expand and, as a result, mobile communications devices have become ubiquitous in both business and personal settings. As the functionally of mobile communications devices and the ease of information transfer continues to increase, users continue to demand more functionality that allows the users to quickly find and interact with more data in unique ways.

Some users expect mobile communication devices to be as powerful as conventional computing systems and offer the same types and levels of network connectivity in a wireless package. Many users desire streamlined connections with both local area networks (LANs) and other networks, such as the Internet, that area available via through a communications core network for mobile communications.

Operators of communication networks may observe that user data traffic increases significantly e.g. due to HSPA (High Speed Packet Access) whereas revenues for operating the network may not increase in the same phase, e.g. due to flat rate charging. Operators may be interested in potential solutions to offload at least some of the increased traffic or user data traffic without carrying that data through the core network in order to save operating costs and to save network capacities.

There may be a need to provide a solution for reducing traffic within a communication network.

### BRIEF SUMMARY

According to an exemplary embodiment of the present invention a method may be provided, which method may comprise receiving a first message comprising a bearer management information for a session of a user, selecting a first network device, wherein the selected first network device may be located in a down-stream direction towards the user and sending a second message comprising the bearer management information of the user to the selected network device.

An operator of a communication network may provide a service for a user or user equipment. Information such as UE information, bearer management information and/or location information may be utilized in order to select the first network device, which network device may provide or prepare a traffic offload function. A down-stream direction may be a direction towards the user. Traffic or messages may flow in a down-stream direction towards the user. Thus, the selected first network device may be located towards the user and an attached core network may operate in an up-stream direction in relation to the user and in relation to the selected first network device. Therefore a traffic offload may take place at the location of the selected first network device, which may be located between the user and the core network. Thus, less traffic may be transported through the core network. The offloaded traffic may take another traffic path and avoiding a path through the core network, i.e. directly to a server or the internet from which the service is provided for the user. For this service, local IP access (LIPA) or selected IP traffic offload (SIPTO) may be applied for the user or user equipment. Thus, the selection of the first network device may be a selection of a break-out gateway (BOGW) or a traffic offload function (TOF) or a local gateway (L-GW). This break-out gateway or traffic offload function or local gateway may provide a decision in relation to traffic provided for a session of the user or user equipment. Thus, the BOGW or TOF or L-GW may decide or may enforce decisions from an external function such as the policy an charging rules function (PCRF) whether an offload may be suitable for providing a service for the user without utilizing a traffic path through the core network. Sending the second message in a down-stream direction may provide bearer management information from the core network to a selected first network device outside the core network or at the entrance or border of the core network. In the second message the BOGW or the TOF or the L-GW may receive relevant information for deciding whether an offload may be suitable. Therefore the offloaded traffic may take a traffic path outside the core network, which may reduce the traffic in the core network.

A RNC of an access network may receive from the core network radio access information, i.e. QoS information. However, the bearer management information sent to the first network device may comprise more information than radio access information. The bearer management information may comprise information for supporting a traffic offload or comprising information for preparing a decision for offloading. It may be possible that the first network device may comprise an offload function.

According to an exemplary embodiment of the present invention, the method may further comprise sending a third message comprising the bearer management information of the user to a second network device, wherein the second network device may be located in an up-stream direction of the user.

An up-stream direction of the user may be understood as a flow direction of messages or signals from the direction of the user or user equipment towards a further network device, for example a network device located in the core network. The third message may provide bearer management information from a network device located outside the core network to a network device located inside the core network. Thus, the third message may provide bearer management information into the core network. It may also be foreseen that the third message may provide bearer management information from a network device located within the core network to another network device located within the core network. Thus, it may be foreseen that the third message may be signalled within the core network.

According to an exemplary embodiment of the present invention, the bearer management information may be at least one information of the group of information consisting of bearer creation information, bearer modification information, bearer deletion information, UE/user information and accounting information. For example at bearer creation, the bearer management information may comprise bearer creation information such as APN, Bearer Type and/or QoS Profile and/or UE/user information such as IMSI and/or MSISDN and accounting information such as Charging Characteristics and/or Charging Gateway/Server Addresses.

It may be foreseen that a request message may comprise bearer management information. Moreover, it may be possible, that a response message may comprise bearer management information.

According to an exemplary embodiment of the present invention, the method may further comprise providing a selection information for selecting a network device.

A selection information may be for example an RNC Id (Radio Network Controller Identity) or eNB Id (Base Station Identity) or RAI (Routing Area Identity) or TAI (Tracking Area Identity) or SAI (Service Area Identity) or CGI (Cell Global Identity).

According to an exemplary embodiment of the present invention, the method may comprise receiving the bearer management information from a network device located in a down-stream direction towards the user.

The network device located in a down-stream direction towards the user may be for example a gateway or functionality co-located with RAN elements such as the RNC or eNB or Home (e)NB GW. The network device located in a down-stream direction may be operating in an access network.

According to an exemplary embodiment of the present invention, the first message may be at least one message of the group of messages consisting of an update message, a modification message, a setup message, an activation message, a deactivation message, a delete message and a relocation message.

The first message may provide bearer management information, e.g. in case a bearer is created or modified or deleted for a user, in case a user enters into a network, in case a user leaves the network, in case the user requests a further service, in case the user moves, etc. Thus, the first message may provide information in order to serve the user or in order to adapt the service for the user.

According to an exemplary embodiment of the present invention the second message may comprise a GTP signaling or a Radius signaling or a Diameter signaling.

A GTP signaling (GTP=GPRS Tunneling Protocol) may be utilized to create or modify or delete bearers in order to transport packets in GPRS. Diameter signaling or Radius signaling may be utilized for authentication, authorization and/or accounting. Diameter signaling or Radius signaling may also be utilized to inform a server on bearer related events such as bearer creation, modification or deletion.

According to an exemplary embodiment of the present invention, the second message may comprise an address of the selected network device.

The address of the selected network device may be utilized for a direct signaling. A direct signaling may provide information directed towards a preselected network device. Thus, there may be no need for interception for that network device in order to receive information. A direct signaling may provide a precise and safe information transmission from a source of information towards a receiver of information.

According to an exemplary embodiment of the present invention, a method may be provided comprising receiving a first message comprising a bearer management information for a session of a user, sending a second message to a network device located in an up-stream direction and routing traffic utilizing the received bearer management information.

The second message may comprise a response to the received bearer management information of a session of a user. For routing traffic it may be foreseen analyzing a plurality of packets received via a bearer service, forwarding packets to a gateway via the bearer service and offloading and routing, from the bearer service, packets to a separate network. The second message may be a create PDP context request message, an update PDP context request message or a delete PDP context request message. Packets from a source may be forwarded to two directions, for example to a first direction towards a gateway and to a second direction towards a separate network, such as the internet.

According to an exemplary embodiment of the present invention, the second message may comprise at least one information of the group of information consisting of a bearer creation information, a bearer modification information, a bearer deletion information, a UE/user information and an accounting information.

A bearer creation information may be e.g. APN, Bearer Type and/or QoS Profile. A bearer modification information may be e.g. QoS Profile. A bearer deletion information may be e.g. one or more identities of the bearer(s) to be deleted. An accounting information may be e.g. Charging Characteristics and/or Charging Gateway/Server Addresses.

According to an exemplary embodiment of the present invention, a network device may be provided comprising a receiving unit for receiving a first message comprising a bearer management information for a session of a user and a sending unit for sending a second message to a first network device located in a down-stream direction.

The network device may comprise a first interface for receiving the first message and may comprise a second interface for sending the second message. It may also be foreseen that the receiving unit and the sending unit may utilize one single interface and may be combined into one single receiving/sending unit. The first message may flow in a down-stream direction or in an up-stream direction. The first message may be received by a support node, such as a SGSN or a GGSN. The second message may flow in a down-stream direction to the first network device. The first network device may be a BOGW or TOF or L-GW which may be located in a down-stream direction, i.e. in a direction from the core network towards the BOGW or TOF or L-GW, wherein the BOGW or TOF or L-GW may be located between the user and the core network.

According to an exemplary embodiment, the network device may be a support node.

A support node may be an SGSN or MME. Moreover a support node may be a gateway, for example a GGSN, a SGW, a PGW or a SGW/PGW. A support node may be a network node, an eNodeB, a HeNodeB, an eNB/L-GW or a HeNB/L-GW.

According to an exemplary embodiment of the present invention, the network device may be located in a core network.

A core network device may be installed in a core network, especially in a communication core network. A core network may comprise a plurality of network devices, i.e. one or a plurality of SGSN and/or one or a plurality of GGSN. A core network may transport traffic from and to an access network of a user. A core network may transport traffic from the core network towards and back from service providers serving a user session of the user. A GGSN may serve as a gateway forwarding user data traffic.

According to an exemplary embodiment of the present invention, a network device may be provided comprising a receiving unit for receiving a first message comprising a bearer management information for a session of a user, a sending unit for sending a second message comprising a response to the received first message to a network device located in an up-stream direction and a routing unit for routing traffic utilizing the received bearer management information.

The network device may be located between an access network and a core network.

According to an exemplary embodiment of the present invention, the network device may comprise a traffic offload function.

A traffic offload function or a traffic break-out function may be provided by a break-out gateway (BOGW) or a TOF. The network device may be a BOGW or a TOF. Moreover, the network device may send a traffic offload information to the up-stream located network device. A routing of traffic may provide an offload within a core network and may therefore reduce traffic. It may be foreseen that the break-out function or a traffic offload function may be at least one of the group of functions consisting of routing of packets, routing of uplink packets, collecting of UL statistics, collecting of DL statistics, gateway bridging, downlink packet buffering, ECM-IDLE mode downlink packet buffering, initiating of network triggered service request procedure, assisting in UE IP-address allocation for accessing a home based network, DHCPv4-functions, DHCPv6 functions, providing server functionalities, providing relay functionalities, providing client functionalities, providing local IP address signaling in control messages, providing local IP address signaling in control messages, such as GTP and NAS and providing downlink local packets in a tunnel, especially providing an inclusion of downlink local packets in a GTP tunnel at an S1-U interface.

A break-out gateway (BOGW) or a TOF may be adapted to support a breakout service or a traffic offload service based on a received information, which information may be at least one of the group of information consisting of a UE Requested PDN Connectivity, a UE Triggered Service Request, a UE Requested Bearer Resource Modification, a Dedicated Bearer Activation, a Bearer Modification, a Network Triggered Service Request, a S1 Release procedure, a UE-initiated Detach procedure for E-UTRAN, a MME Initiated Dedicated Bearer Deactivation, a UE Requested PDN disconnection and a Create/Update (Default) Bearer Request.

According to an exemplary embodiment of the present invention, a communication system may be provided, wherein the communication system may comprise a first network device according to the present invention and a second network device according to the present invention.

The communication system may comprise a BOGW and a SGSN. Moreover, the communication system may comprise a BOGW and a GGSN. It may also be possible that the communication system comprises a first network device according to the present invention, a second network device according to the present invention and a third network device according to the present invention. Therefore, the communication system may comprise for example a BOGW, a SGSN and a GGSN.

According to an exemplary embodiment of the present invention, a computer program product may be provided comprising code portions for causing a network device, on which the computer program may be executed to carry out a method according to the present invention.

The exemplary embodiments of the present invention in relation to network devices may comprise a processor, which processor may be adapted to carry out the methods according to exemplary embodiments of the present invention. This processor may utilize the computer program product in order to perform the methods according to the present invention.

According to an exemplary embodiment of the present invention, the computer-readable medium may be provided embodying the computer program product according to the present invention.

### BRIEF DESCRIPTION OF THE DRAWINGS

Embodiments of the present invention are described below with reference to the accompanying drawings, which are not necessarily drawn to scale, wherein:

FIG. 1 illustrates a communication system according to an exemplary embodiment of the present invention;

FIG. 2 illustrates a communication system according to an exemplary embodiment of the present invention;

FIG. 3 illustrates a message flow diagram according to an example embodiment of the present invention;

FIG. 4 illustrates a message flow diagram according to an example embodiment of the present invention;

FIG. 5 illustrates a message flow diagram according to an example embodiment of the present invention;

FIG. 6 illustrates a message flow diagram according to an example embodiment of the present invention;

FIG. 7 illustrates a communication system according to an exemplary embodiment of the present invention;

FIG. 8 illustrates a message flow diagram according to an example embodiment of the present invention;

FIG. 9 illustrates a message flow diagram according to an example embodiment of the present invention;

FIG. 10 illustrates a message flow diagram according to an example embodiment of the present invention;

FIG. 11 illustrates a message flow diagram according to an example embodiment of the present invention;

FIG. 12 illustrates a network apparatus according to an exemplary embodiment of the present invention;

FIG. 13 illustrates a method according to an exemplary embodiment of the present invention; and

FIG. 14 illustrates a method according to an exemplary embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. The terms “data,” “content,” “information”, “message”, “parameter” and similar terms may be used interchangeably, according to some example embodiments of the present invention, to refer to data capable of being transmitted, received, operated on, and/or stored.

The illustration of the drawings is schematic. In different drawings, similar or identical elements are provided with the same reference numerals.

Various example embodiments of the present invention support communications traffic offload from a bearer service. According to various example embodiments, a bearer service may be a type of virtual point-to-point connection or transport service between two or more network entities or end points. For example, the bearer service may be a packet data protocol (PDP) context and/or a enhanced packet system (EPS) bearer. As such, the bearer service may support generic packet radio service (GPRS) and/or long-term evolution (LTE) based communications techniques. Moreover, the bearer service may support CDMA access or any other access technology. The end points of the bearer service may be a client device, such as, for example, user equipment (UE) in the form of a mobile terminal, and a gateway, such as, for example, a packet data network gateway (PDN-GW) and/or a general packet radio service (GPRS) gateway support node (GGSN). In some example embodiments, a bearer service is a transport service with specific and defined quality of service (QoS) attributes. In addition, not only GPRS or LTE techniques may be utilized in this context. Offload situations may also happen in other networks or accesses, e.g. in CDMA access. In this context, the term “user”, “client”, “client device”, “user equipment”, “UE” or similar terms may be utilized interchangeably.

According to various example embodiments of the present invention, a client device or a user equipment may maintain a bearer service to a gateway or a server that may provide access in a core network of a wireless communications system. Having established the bearer service with the gateway, communications traffic may selectively be offloaded from the bearer service to a second network in order to avoid carrying that communications traffic through the core network. Offloading communications traffic may be done in an intermediate middlebox, also called Breakout Gateway (BOGW) or the Traffic Offload Function (TOF) or in a Local Gateway (L-GW). The client device or user equipment may also wish to communicate, i.e. more locally, with a second, separate network, such as a local area network (LAN). To conduct communications with this second network, the client device may be configured to transmit packets intended for the second network through the bearer service to an intermediate middlebox or BOGW or a local breakout gateway (L-GW).

The middlebox or BOGW may be configured to forward packets intended for the core network towards the gateway, and offload and route packets intended to the second network to the second network. Rules for packet forwarding may be either pre-configured to the middlebox or BOGW or may be sent to the middlebox or BOGW from an external server e.g. from the PCRF. Since the packets intended for the second network may be intercepted by the middlebox or BOGW, the gateway and the core network may be unaware of the packets offloaded and routed to the second network. In this manner, simultaneous support for both core network communications and local area network communications may be achieved through multiple interfaces via a single bearer service. Example embodiments therefore may support local IP access (LIPA), without visibility, or with limited visibility, to the core network.

A bearer service for the client device or user equipment may provide bearer management information for one or a plurality of network devices. Bearer management information may be sent to a network device as a direct signaling whereas other network devices may intercept the bearer management information without being directly addressed. In the following embodiments a direct signaling of bearer information is illustrated. The term “direct” in this context means that the relevant information may be sent directly to a certain network device without sniffing the information. A direct signaling may comprise a selection of a certain network device and addressing the message comprising the bearer management information message to this network device explicitly. This may be indicated in the illustrated message flow diagrams by arrows ending at the respective network device comprising a destination address for the management bearer information. In the following it may be illustrated how a network device, i.e. the BOGW may be provided with bearer management information, which bearer management information is provided by a network device of a core network. The core network may comprise several network support nodes which may be located in an up-stream direction in relation to the user or user equipment and also in an up-stream direction in relation to the BOGW. Thus, the BOGW may be located between the user equipment and the core network. From the view point of the BOGW the user equipment may be located in a down-stream direction and the network devices of the core network are located in an up-stream direction in relation to the BOGW and also in relation to the user equipment.

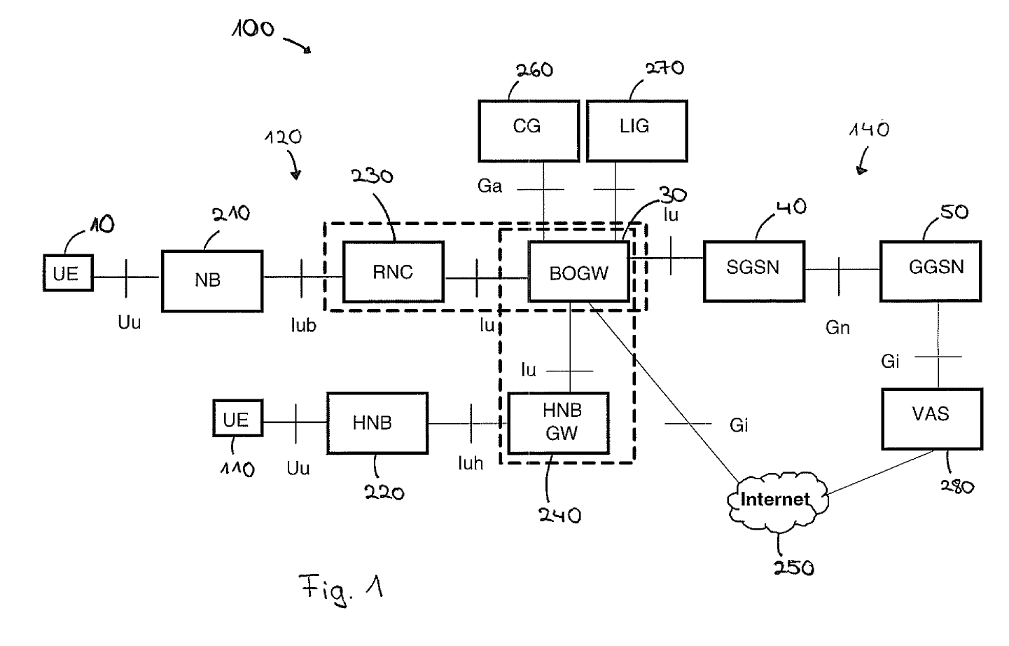

FIG. 1 illustrates a reference architecture of a communications network. The network 100 shows a client or user or user equipment (UE) 10 in a network and a client, user or user equipment (UE) 110 at home with femto access. The network 100 may comprise an access network 120 and a core network 140. The network 100 of FIG. 1 may comprise a NB 210, a RNC 230, a BOGW 30, a SGSN 40, a GGSN 50, a VAS 280, a HNB 220, a HNBGW 240, a CG 260 and a LIG 270. The user 10, 110 may be any type of wired or wireless communication device such as a mobile terminal, a laptop computer with a wireless modem, or other type of user equipment. The BOGW 30 may connect a radio access network 120 comprising a NB 210 and a RNC 230 to the core network 140 comprising a SGSN 40 and a GGSN 50. A bearer service may be established between the user 10 or 110 and a gateway such as GGSN 50. According to an exemplary embodiment, the bearer service may support a virtual connection and be configured as, for example a PDP context and/or an EPS bearer. The bearer service may pass through the BOGW and the BOGW 30 may be configured to maintain information of the bearer service between the client 10, 110 and a gateway such as GGSN 50.

In general, the client 10, 110 may be configured to provide communications traffic via the bearer service. The BOGW 30 may be configured to analyze packets, especially IP packets, to determine whether the packets are forwarded to the core network or to the second network. Thus, the BOGW 30 may provide a selection information for routing packets to multiple networks.

The network devices 30, 40, 50, 210, 220, 230, 240, 260, 270, 280 of the network 100 and the internet 250 may be interconnected to each other via interfaces, in example interfaces Uu, Iub, Iu, Iuh, Ga, Gn, and Gi. It may be understood, that further interfaces may be present but not shown in the figures.

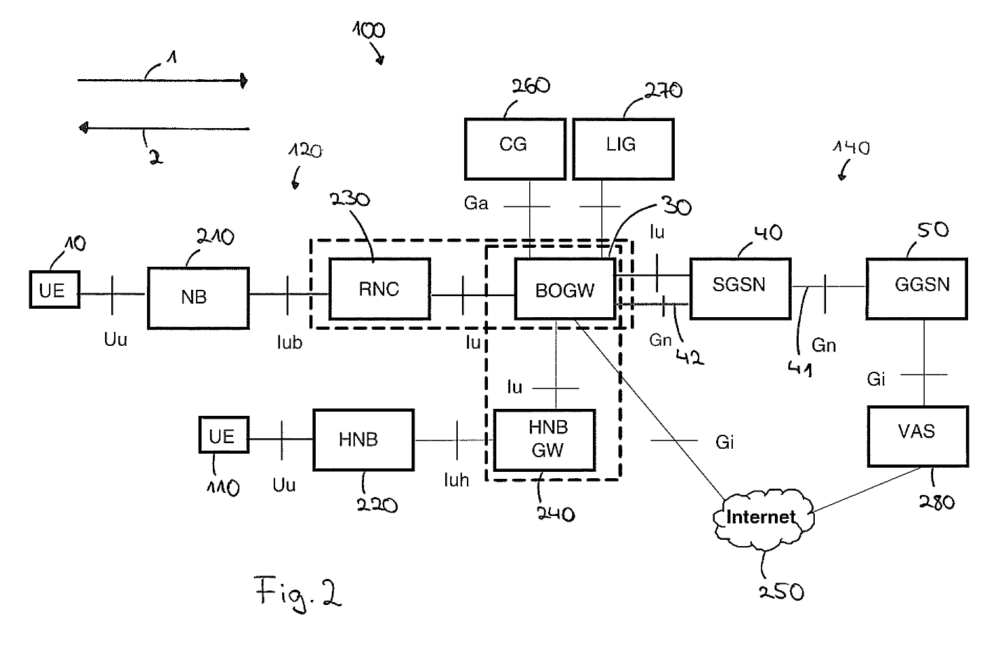

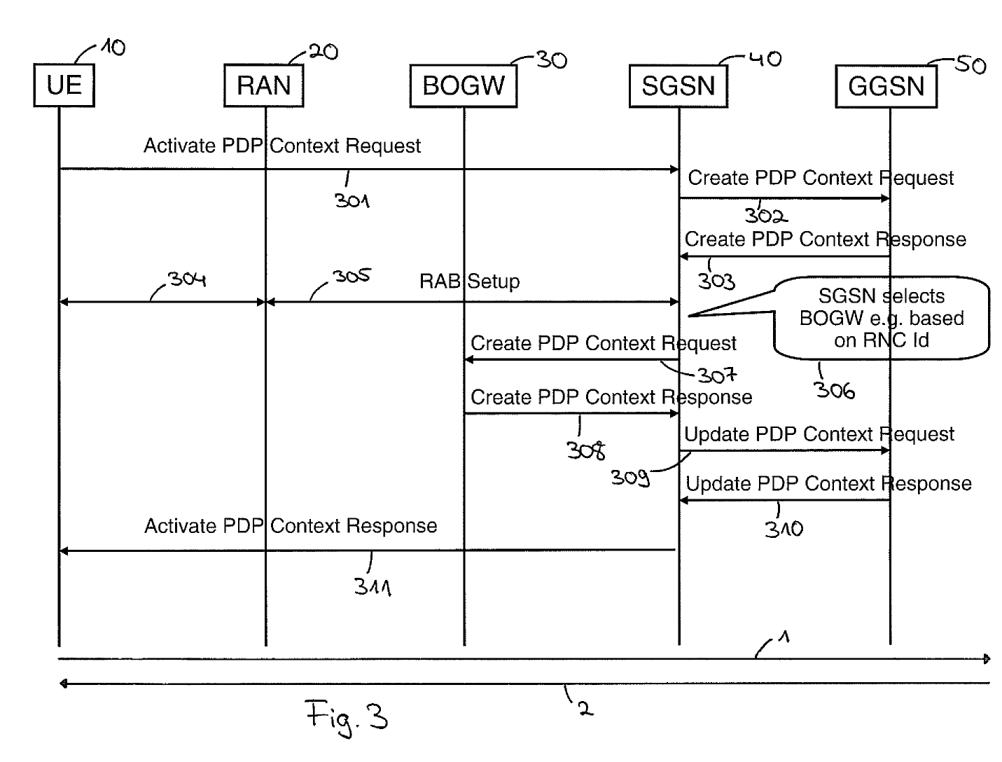

In FIG. 2 the SGSN 40 may comprise a first Gn-interface 41 and a second Gn-interface 42. The BOGW 30 and the SGSN 40 may be connected via the Gn-interface 42 according to an exemplary embodiment of the present invention.. Thus the SGSN 40 may signal over the first Gn-interface 41 in an up-stream direction 1. Moreover, the SGSN 40 may signal over the second Gn-interface 42 in a down-stream direction 2. The Gn-interfaces 41, 42 may be utilized for GTP signaling according to exemplary embodiments illustrated in FIG. 3-FIG. 6.

In FIG. 7 the GGSN 50 may comprise a first Gi-interface 51 and a second Gi-interface 52. The BOGW 30 and the GGSN 50 may be connected via the Gi-interface 52 according to an exemplary embodiment of the present invention. Thus the GGSN 50 may signal over the first Gi-interface 51 in an up-stream direction 1. Moreover, the GGSN 50 may signal over the second Gi-interface 52 in a down-stream direction 2. The Gi-interface may be utilized for Radius signaling or Diameter signaling, according to exemplary embodiments illustrated in FIG. 8-FIG. 11.

In FIG. 2 the SGSN 40 may provide a GTP signaling via the Gn-interfaces 41, 42, respectively. Thus, the SGSN 40 may provide GTP signaling towards the BOGW 30 and in addition the SGSN 40 may provide GTP signaling towards the GGSN 50. This signaling towards two directions may be performed simultaneously or timely shifted. From this GTP signaling, the BOGW 30 may receive relevant parameters of the UE and bearer, e.g. IMSI, MSISDN, APN, charging characteristics, UL TEID, DL TEID, etc. Therefore, the SGSN 40 may signal towards two directions, in example to the GGSN in an up-stream direction 1 and to the BOGW 30 in a down-stream direction 2.

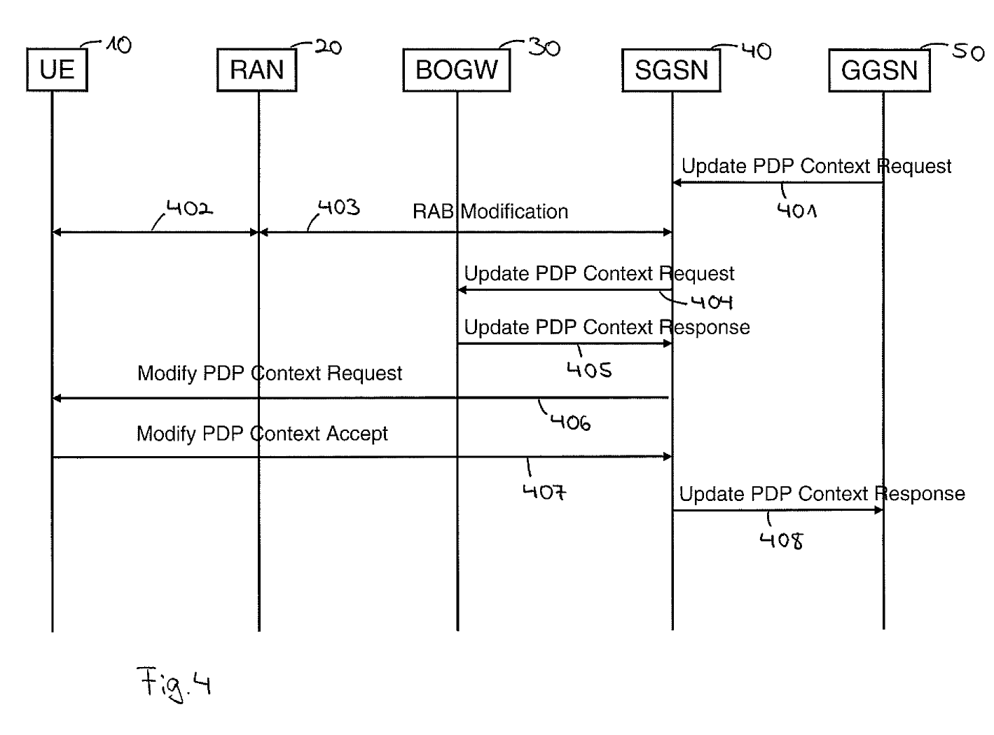

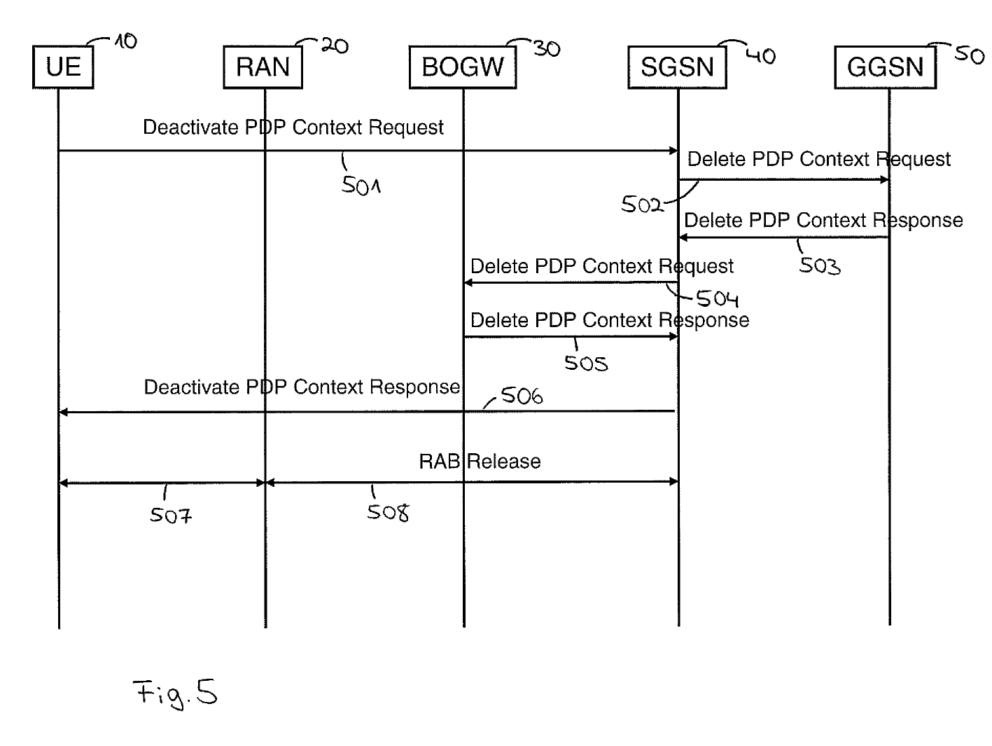

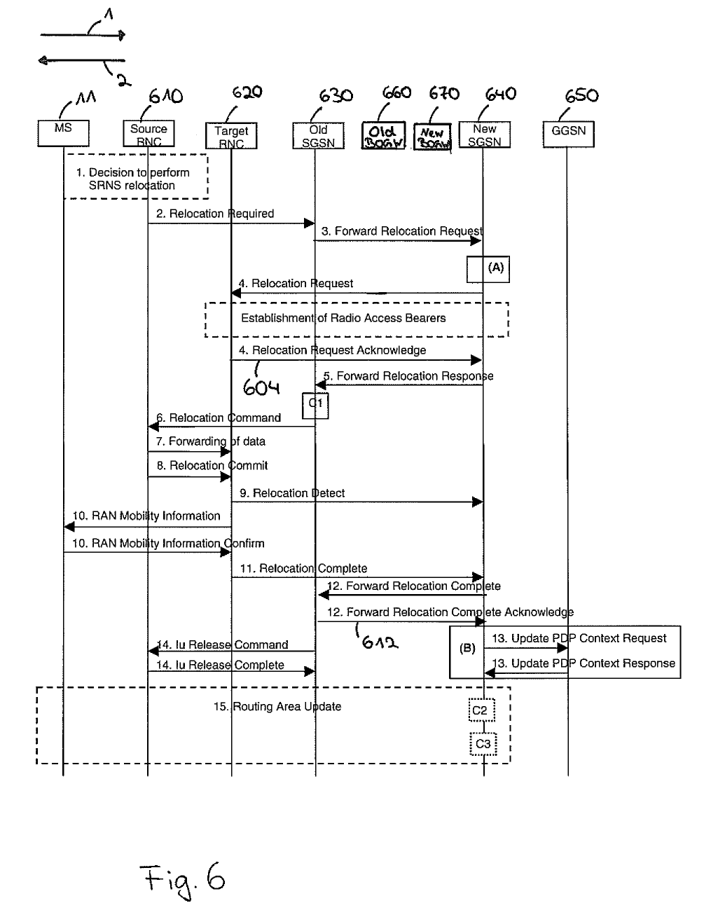

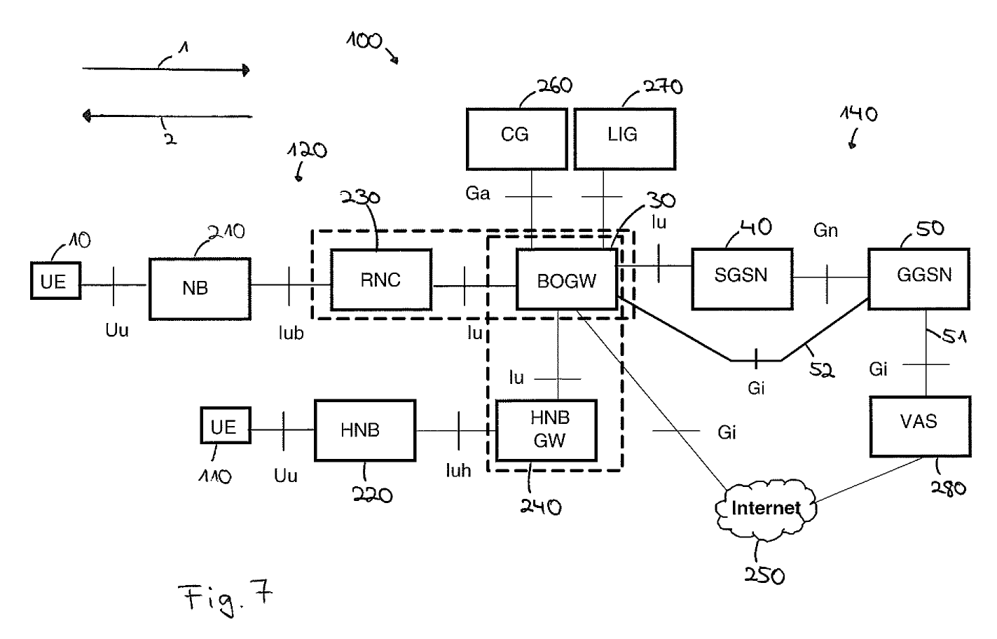

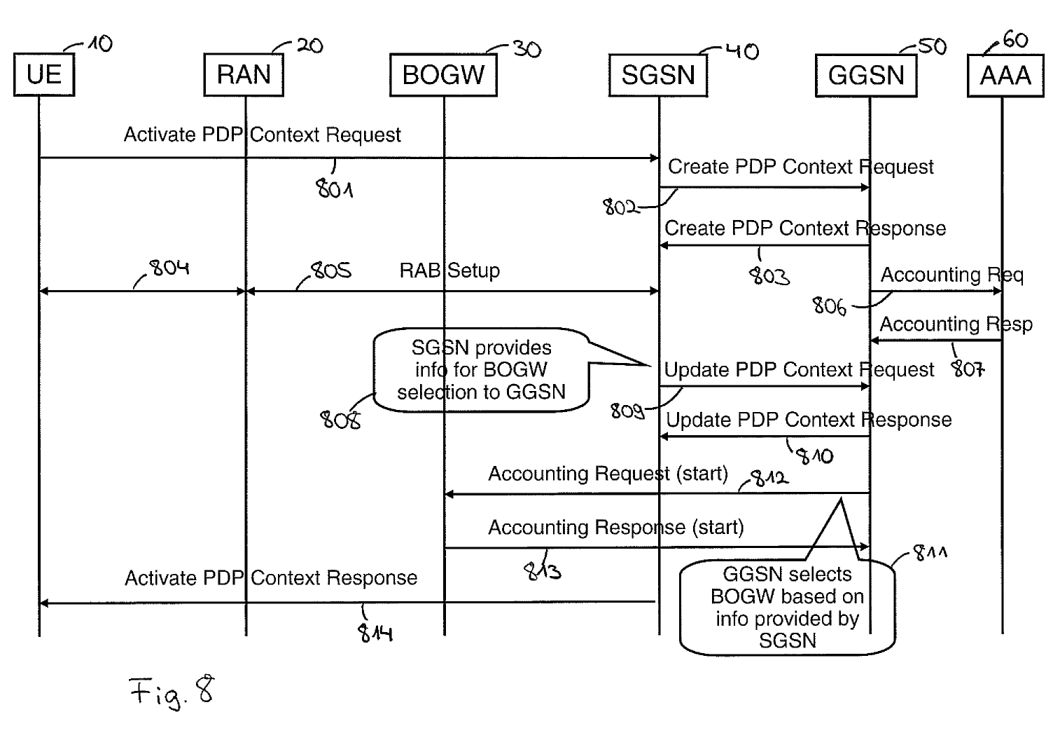

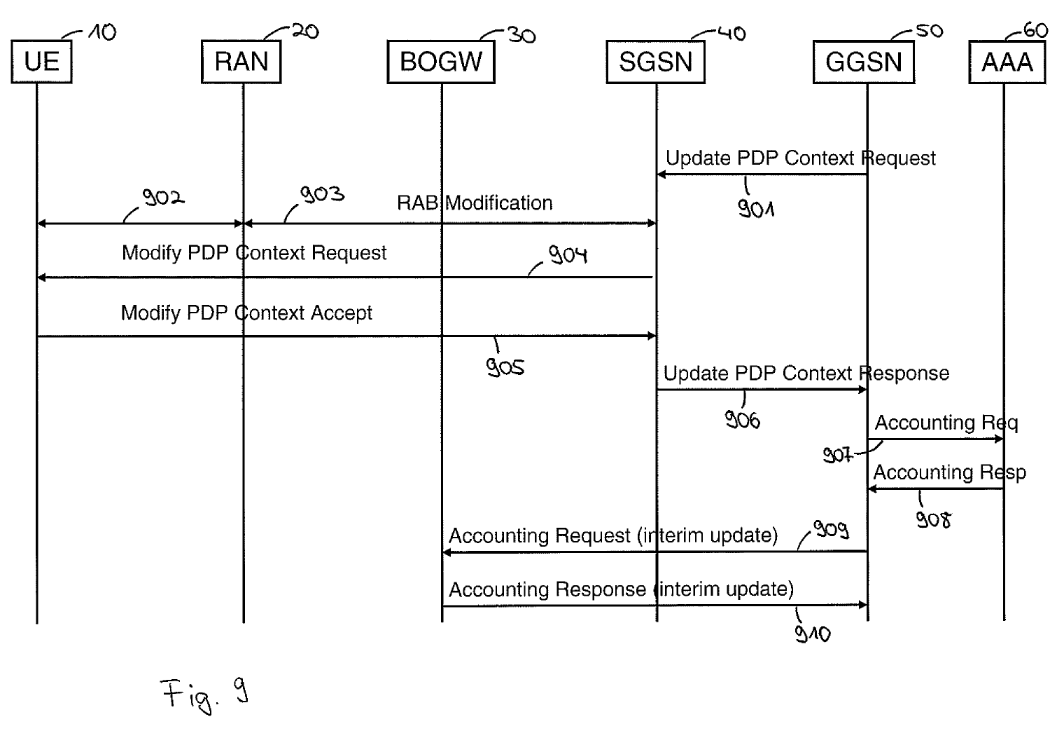

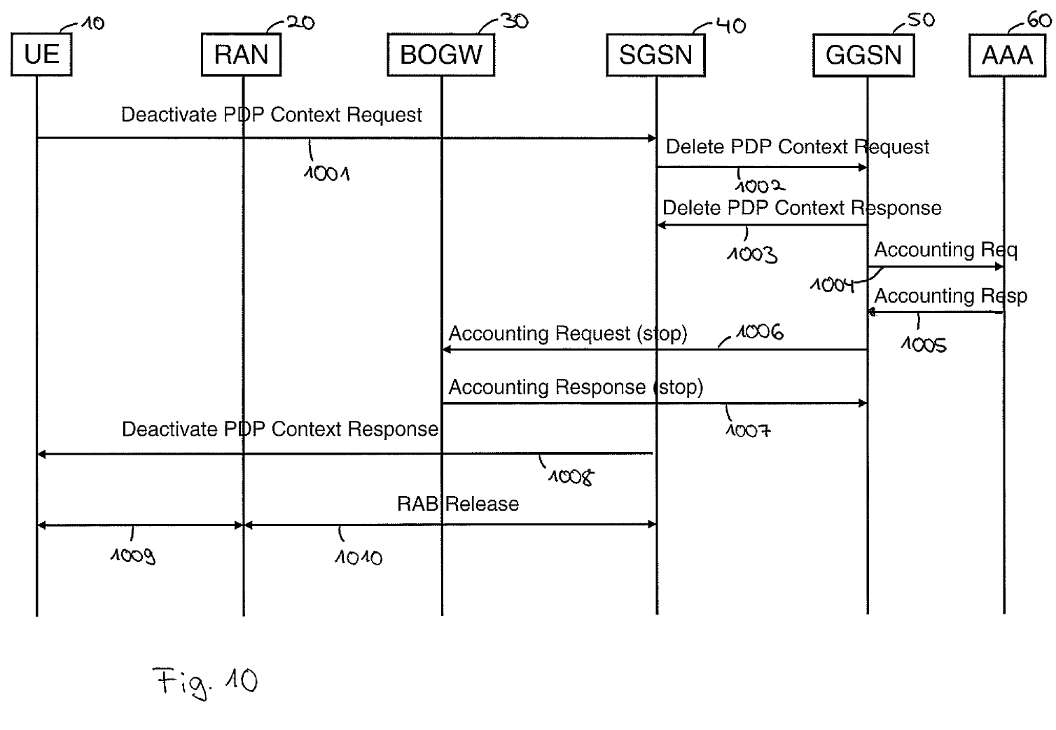

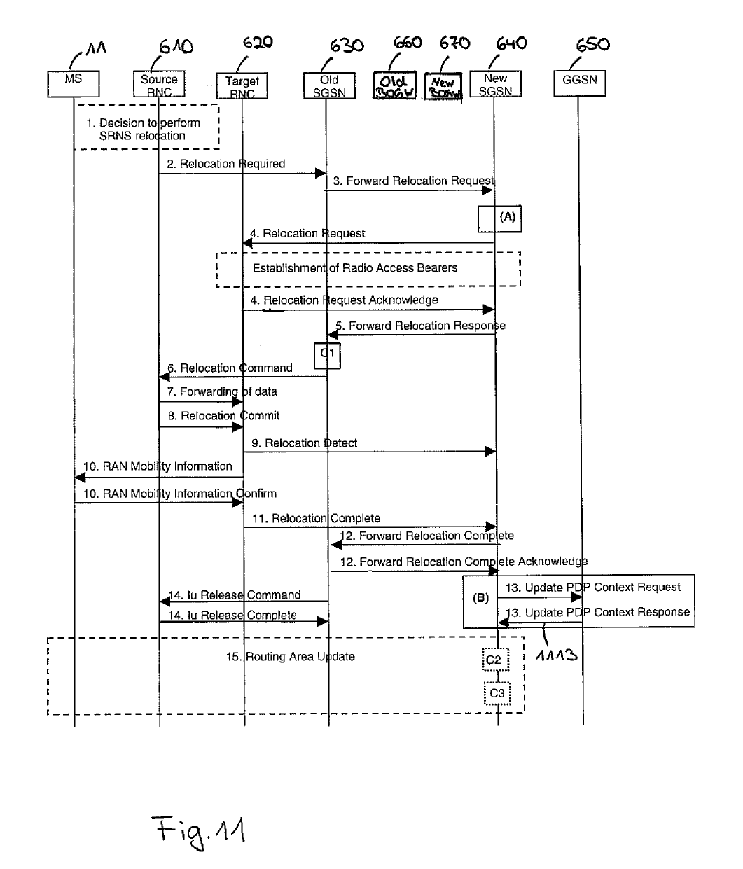

FIG. 3, FIG. 4, FIG. 5 and FIG. 6 show exemplary embodiments for GTP signaling, respectively. FIG. 8, FIG. 9, FIG. 10 and FIG. 11 show exemplary embodiments for Radius signaling or Diameter signaling, respectively. These FIGS. 3-6 and 8-11 show exemplary signaling for creating, modifying and deleting UE and bearer information in the BOGW 30.

In FIG. 3, FIG. 4 and FIG. 5 user equipment (UE) 10, a RAN 20, a BOGW 30, a SGSN 40 and a GGSN 50 are shown in exemplary message flow diagrams. Further message diagrams are shown in FIGS. 7 and 11. All figures show exemplary embodiments for methods according to exemplary embodiments of the present invention. In these figures several steps may be indicated by numerals either at an arrow or in a box. These steps may be performed timely after each other. Moreover, the arrows may indicate a direction of information flow from one network device to another network device. Boxes in these figures may indicate actions taken by the respective network device or decisions to be performed by a respective network device. The text positioned at the respective arrow may indicate a message comprising parameters indicated. In FIG. 3 the up-stream direction 1 and the down-stream direction 2 is indicated by arrows, respectively. This definition of the up-stream direction 1 and the down-stream direction 2 is valid for all Figures.

FIG. 3 shows a bearer creation procedure. The UE 10 sends a message 301 to the SGSN 40, wherein this message comprises the information of “activate PDP context request”. The SGSN 40 sends a message 302 towards the GGSN 50 comprising the information of “create PDP context request”. The GGSN 50 responds to this message by sending the message 303 towards the SGSN 40. In message 304 an information exchange takes place between the UE 10 and the RAN 20. Moreover, in message 305 an information exchange takes place between the RAN 20 and the SGSN 40 comprising a “RAB setup”. After receiving the request message 301 and the information exchange message 305 the SGSN 40 may select among different BOGWs the BOGW 30, for example based on a RNC Id, which is indicated in box 306. The SGSN 40 sends a message 307 comprising UE and bearer management information to the selected BOGW 30. The message 307 may comprise the information of “create PDP context request”. The BOGW 30 may receive this message 307 and responds with a further message 308 comprising the information of “create PDP context response”. Both messages 307 and 308 may comprise all or a subset of parameters available in a common GTP signaling message. Moreover, the messages 307 and 308 are GTP. Therefore, the messages 307, 308 are GTP signaling messages, respectively. The SGSN 40 may receive the message 308 and may send an update request message 309 towards the GGSN 50 comprising the information of “update PDP context request”. Afterwards, the GGSN 50 may send a further message 310 as response message towards the SGSN 40 comprising the information of “update PDP context response”. Finally, the SGSN 40 may send a response message 311 in a down-stream direction 2 towards the UE 10 comprising the information of “activate PDP context response”.

FIG. 4 illustrates a bearer modification procedure. In FIG. 4, bearer modification may be initiated by the GGSN. Bearer modification may also be initiated e.g. by the UE or SGSN. In message 401 the GGSN 50 sends a request message in a down-stream direction 2 towards the SGSN 40. The SGSN 40 and the RAN 20 may exchange information in a RAB modification message 403. Moreover, the RAN 20 and the UE 10 may also exchange modification information in a message 402. The BOGW 30 may receive a message 404 from the SGSN 40. This message 404 may comprise UE and bearer management information for the bearer service of the user UE 10 which may be information of “update PDP context request”. The message 404 from the SGSN 40 to the BOGW 30 in a down-stream direction 2 may be responded by a further message 405 comprising a response to the received bearer management information of message 404. The message 405 sent from the BOGW 30 in an up-stream direction 1 towards the SGSN 40 may comprise “update PDP context response” information. Both messages 404 and 405 may comprise all or a subset of parameters available in a common GTP signaling message. In message 406 the SGSN 40 may send a “modify PDP context request” to the UE 10 in a down-stream direction 2. The UE 10 may send a further message 407 to the SGSN 40 comprising “modify PDP context accept” information. Moreover, the SGSN 40 may send a message 408 in an up-stream direction 1 towards the GGSN 50, wherein the message 408 may comprise “update PDP context response” information.

FIG. 5 illustrates an exemplary embodiment of a bearer deletion procedure. In FIG. 5, bearer deletion may be initiated by the UE 10. Bearer deletion may also be initiated e.g. by the GGSN 50 or SGSN 40. The deactivation may be UE initiated by sending a message 501 from the UE 10 in an up-stream direction 1 towards the SGSN 40. The message 501 may comprise “deactivate PDP context request” information. The SGSN may send a request message 502 in an up-stream direction 1 towards the GGSN 50, wherein the message 502 may comprise “delete PDP context request” information. In addition, the GGSN 50 may send a response message 503 comprising “delete PDP context response” information back to the SGSN 40. The SGSN 40 may send in an up-stream direction 1 a message 504 comprising “delete PDP context request” information. This message 504 may be received by the BOGW 30, wherein the BOGW 30 may response to the received message 504 with a further message 505. The message 505 may comprise “delete PDP context response” information. The message 505 may be received by the SGSN 40. Both messages 504 and 505 may comprise all or a subset of parameters available in a common GTP signaling message. Moreover, the SGSN 40 may send a message 506 in a down-stream direction 2 towards the UE 10 comprising “deactivate PDP context response” information. In a message 507 the UE 10 and the RAN 20 may exchange information in relation to the bearer management. Moreover, the RAN 20 may exchange information with the SGSN 40 with the message 508 comprising “RAB release” information.

FIG. 6 shows a further exemplary embodiment of the present invention for a procedure providing RNC relocation which may result in changing the RNC and BOGW. FIG. 6 shows a mobile station (MS) 11, a source RNC 610, a target RNC 620, an old SGSN 630, a new SGSN 640 and a GGSN 650. Message flows between the network devices in FIG. 6 are indicated by arrows and decision boxes 1-15. It may be foreseen that in FIG. 6 also a new an old BOGW 660 and a new BOGW 670 may be present. After a relocation request acknowledge 604 from the target RNC 620 to the new SGSN 640, the new SGSN 640 may signal with the new BOGW 670 in order to provide UE and bearer information to the new BOGW 670. This signaling may comprise a request message and a response message as indicated in FIG. 3 between the SGSN 40 and the BOGW 30. Thus, the new SGSN 640 may send a request message 307 towards the new BOGW 670, as indicated in FIG. 6, wherein the message 307 may comprise “create PDP context request” information. The BOGW 30 in FIG. 6 and the new BOGW 670 in FIG. 6 may send a response message 308 in an up-stream direction 1 towards the new SGSN 640 comprising “create PDP context response” information. Moreover, the old SGSN 630 in FIG. 6 may send a message towards the old BOGW 660 after step 612 in FIG. 6. The old SGSN 630 may send a request message 504 as indicated in FIG. 5. This request message 504 may comprise “delete PDP context request” information. The message 504 may be received by the old BOGW 660. Moreover, the old BOGW 660 may send a further message 505 as indicated in FIG. 5 comprising “delete PDP context response” information towards the old SGSN 630.

FIG. 7, FIG. 8, FIG. 9, FIG. 10 and FIG. 11 show exemplary embodiments of the present invention utilizing radius signaling messages or diameter signaling messages. FIG. 7 illustrates an exemplary embodiment of the present invention with a network architecture comprising a core network with a SGSN 40 and a GGSN 50. The GGSN 50 is connected via a Gi-interface with the BOGW 30. Moreover, the GGSN comprises a Gi-interface for a connection to the VAS 280. Over these Gi-interfaces radius signaling or diameter signaling may be provided. In the following figures this radius signaling is described in more detail.

In FIG. 7 the GGSN 50 may utilize radius signaling or diameter signaling towards the BOGW 30. With the radius signaling or diameter signaling the BOGW 30 may receive the relevant parameters of the UE/bearer, e.g. IMSI, MSISDN, APN, charging characteristics, UL TEID, DL TEID, etc. This means, that the GGSN 50 may signal with radius signaling or diameter signaling towards two directions, towards a down-stream direction 2 to the BOGW 30 and towards an up-stream direction 1 to a AAA-server. This signaling towards two directions may be performed simultaneously or timely shifted.

In both exemplary embodiments, according to FIG. 2 and to FIG. 6, which may also be combined within one embodiment, utilizing the GTP signaling and the radius/diameter signaling, respectively, the SGSN 40 or the GGSN 50 may select the BOGW 30. This selection may be performed with the RAN element Id (e.g. with an RNC Id (Radio Network Controller Identity) or eNB Id (Base Station Identity)) or with location information (e.g. with RAI (Routing Area Identity) or TAI (Tracking Area Identity) or SAI (Service Area Identity) or CGI (Cell Global Identity)). As an example, in the RNC level solution, the RAN element Id may be the RNC Id. The SGSN 40 may send the selection information to the GGSN 50. As an alternative, the SGSN 40 may also select the BOGW 30 and may send the address or domain name of the BOGW 30 to the GGSN 50. The BOGW 30 may store the UE and bearer parameters initially but may also store these parameters after they have been changed. The SGSN 40 or the GGSN 50 may signal to the BOGW 30 also when the parameters have been changed. In addition, when the UE 10 may leave the area served by the BOGW 30, the UE and bearer parameters may be deleted in the BOGW 30. As an example in the RNC level solution this may happen at RNC relocation. The SGSN 40 or the GGSN 50 may signal with the BOGW 30 to delete the UE and bearer parameters.

In FIG. 8 a UE initiated bearer creation procedure is illustrated. The UE 10 may send a message 801 comprising “activate PDP context request” information towards the SGSN 40. The SGSN may send a message 802 to the GGSN 50 comprising “create PDP context request” information. The GGSN 50 may send a response message 803 comprising “create PDP context response” information. This message 803 may be received by the SGSN 40. Moreover, the SGSN may provide an information exchange with the RAN 20 utilizing message 805 which comprises a “RAB setup” information. Moreover, the RAN 20 may exchange information with the UE 10 via a message 804. In addition, the GGSN 50 may send a request message 806 comprising “accounting request” information to a AAA-server 60. The AAA-server 60 may send a response 807 back to the GGSN 50 comprising “accounting response” information. The SGSN 40 may provide a selection information (e.g. RAN element identity and/or location information and/or BOGW address or domain name) for selecting a BOGW 30. This selection information of box 808 may be sent by the SGSN 40 to the GGSN 50 utilizing a message 809. The message 809 may comprise “update PDP context request” information. The GGSN 50 may respond to this message by a further message 810, which may comprise “update PDP context response” information. Moreover, the GGSN 50 may select a BOGW based on the information provided by the SGSN 40. This is indicated in box 811. Moreover, the GGSN 50 may send a message 812 to the BOGW 30 comprising “accounting request start” information. The BOGW 30 may respond to this received message 812 by a further message 813. The message 813 may comprise “accounting response start” information. The message 812 and the message 813 may be radius signaling messages, respectively. These messages 812, 813 may comprise all or a subset of parameters available in common radius signaling messages. Moreover, the SGSN 40 may send a message 814 to the UE 10, wherein the message may comprise “activate PDP context response” information.

FIG. 9 illustrates a further exemplary embodiment of the present invention for a procedure providing a bearer modification information towards the BOGW 30. The GGSN 50 may send a message 901 comprising “update PDP context request” information. This message 901 may be received by the SGSN 40. The SGSN 40 may exchange information with the RAN 20 via a message 903 comprising “RAB modification” information. Moreover, the RAN 20 may exchange information with the UE 10 via a message 902. The UE 10 may receive a request message 904 from the SGSN 40 comprising “modify PDP context request” information. The UE 10 may respond to this message 904 by a further message 905 comprising “modify PDP context accept” information which may be sent from the UE 10 to the SGSN 40. The SGSN 40 may send a further message 906 comprising “update PDP context response” information to the GGSN 50. The GGSN 50 may send a message 907 to the AAA-server 60 comprising “accounting request” information. The AAA-server 60 may respond with a message 908 sent to the GGSN 50 comprising “accounting response” information. In addition, the GGSN 50 may send a message 909 to the BOGW 30. The message 909 may comprise “accounting request interim update” information. The BOGW 30 may respond to this received message 909 with a further message 910. This message 910 may be sent to the GGSN 50 comprising “accounting response interim update” information. The messages 909 and 910 may be radius signaling messages. These messages 909, 910 may comprise all or a subset of parameters available in common radius signaling messages.

FIG. 10 shows a further exemplary embodiment of a procedure for a deactivation or deletion of bearer information. The UE 10 may send a message 1001 comprising “deactivate PDP context request” information to the SGSN 40. The SGSN 40 may send a message 102 to the GGSN 50 comprising “delete PDP context request” information. The GGSN 50 may respond to this message with a message 103 comprising “delete PDP context response” information. This message 103 may be sent to the SGSN 40. Moreover, the GGSN 50 may send a message 1004 to the AAA-server 60 comprising “accounting request” information. The AAA-server 60 may respond to this message with a message 105 comprising “accounting response” information. This message 1005 may be received by the GGSN 50. In addition, the GGSN 50 may send a message 1006 to the BOGW 30 comprising “accounting request stop” information. The BOGW 30 may respond to this message by a message 1007. The message 1007 may comprise “accounting response stop” information. This message 1007 may be received by the GGSN 50. The messages 1006 and 1007 may be radius signaling messages. These messages 1006, 1007 may comprise all or a subset of parameters available in common radius signaling messages. Moreover, the SGSN 40 may send to the UE 10 a message 1008 comprising “deactivate PDP context response” information. The UE 10 may exchange information in message 1009 with the RAN 20. The RAN 20 may exchange information with the SGSN 40 comprising “RAB release” information.

FIG. 11 shows a further exemplary embodiment of the present invention for a procedure providing RNC relocation. FIG. 11 shows a mobile station (MS) 11, a Source RNC 610, a Target RNC 620, an old SGSN 630, a new SGSN 640 and a GGSN 650. Message flows between the network devices in FIG. 11 are indicated by arrows and boxes 1-15. It may be foreseen that in FIG. 11 also a new BOGW 670 and an old BOGW 660 may be present. The GGSN 650 may signal with the new BOGW 670 after step 1113 of FIG. 11. It may be foreseen that after step 1113 a message 812 and a message 813 as indicated in FIG. 8 are sent. The message 812 may comprise “accounting request start” information and may be sent from the GGSN 650 to the new BOGW 670. Moreover, the new BOGW 670 may respond to this message by message 813 comprising “accounting response start” information. This message 813 may be received by the GGSN 650. Moreover, the GGSN 650 may signal with the old BOGW 660 after step 13 or after sending of message 1113 to the New SGSN 640 in FIG. 11. In FIG. 11 the GGSN 650 may send a message 1006 to the old BOGW 660 and the old BOGW 660 may send a message 1007 to the GGSN 650 as indicated in FIG. 10. The message 1006 may comprise “accounting request stop” information and the message 1007 may comprise “accounting response stop” information as indicated in FIG. 10. In order to select the new BOGW 670 the GGSN 650 may need information from the new SGSN 640.

Exemplary embodiments have been described for 3GPP technology. Similar solutions may be utilized in LTE technology, wherein a MME may signal to the BOGW instead of the SGSN and wherein a PGW may signal to the BOGW instead of the GGSN. In LTE, the RAN element Id may be the eNB Id.

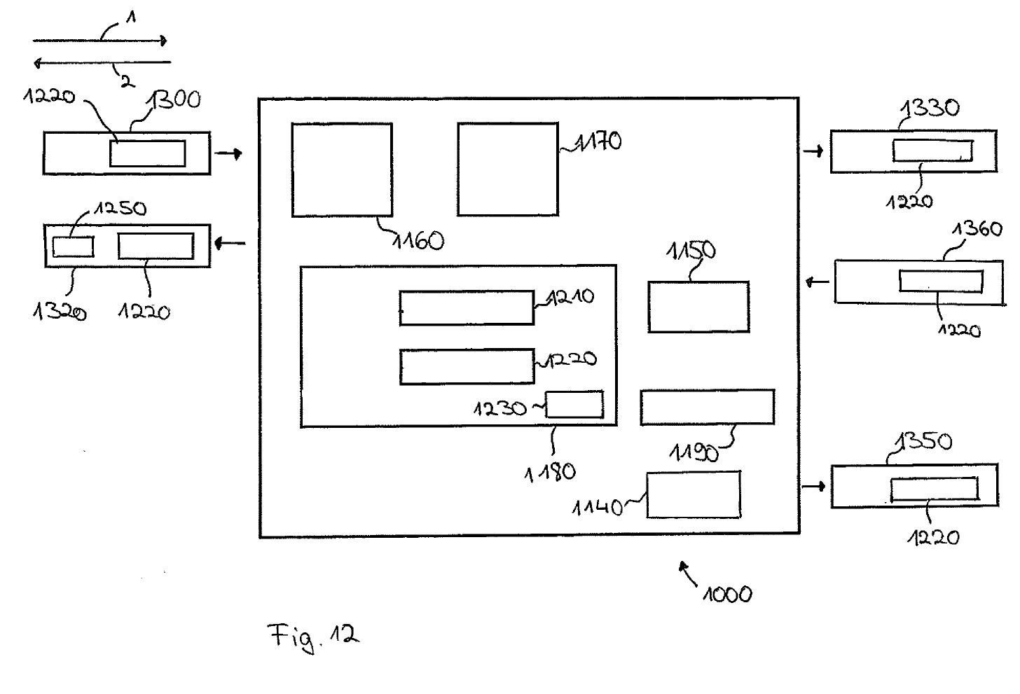

FIG. 12 illustrates a network device 1000 according to an exemplary embodiment of the present invention. The network device 1000 may comprise a receiving unit 1160 for receiving messages, i.e. for receiving a first message 1300 comprising a bearer management information 1220 for a session of a user 10, 110. Moreover, the network device may comprise a sending unit 1170 for sending a second message 1320 comprising a response to the received first message 1300 to a first network device 30 located in a down-stream direction 2. The second message 1320 may comprise an address 1250 of the selected network device. In addition, the network device 1000 may utilize the sending unit 1170 for sending a third message 1330 comprising a response to the received first message 1300 to a network device located in an up-stream direction 1. Moreover, the network device 1000 may send a fourth message 1350 comprising bearer management information 1220 towards the up-stream direction 1 to a further network device. Moreover, the network device 1000 may receive a fifth message 1360 comprising bearer management information 1220 for a session of a user 10, 110.

It may also be foreseen that the network device 1000 of FIG. 12 may comprise a routing unit 1150 for routing traffic utilizing the received bearer management information 1220. Moreover, the network device may comprise a processor 1190 and a memory 1180. The processor 1190 may be adapted to execute a computer program comprising program code. The memory 1180 may store the bearer management information and may store in addition an update 1210 of the bearer management information. The update may be received by the network device 1000 from a further network device located in an up-stream direction 1 or located in a down-stream direction 2. Moreover, the memory 1180 of the network device 1000 of FIG. 12 may store a selection information 1230. This selection information 1230 may be received from a further network device located in an up-stream direction 1 or located in a down-stream direction 2. Thus, the network device 1000 of FIG. 12 may send the selection information 1230 to a further network device, for example to a network device comprising an offload function, such as a BOGW 30. The network device 1000 or the BOGW 30 may comprise a routing unit 1140 for routing traffic and for providing traffic offload. For providing a decision for routing traffic and for providing traffic offload the bearer management information 1220 may be utilized.

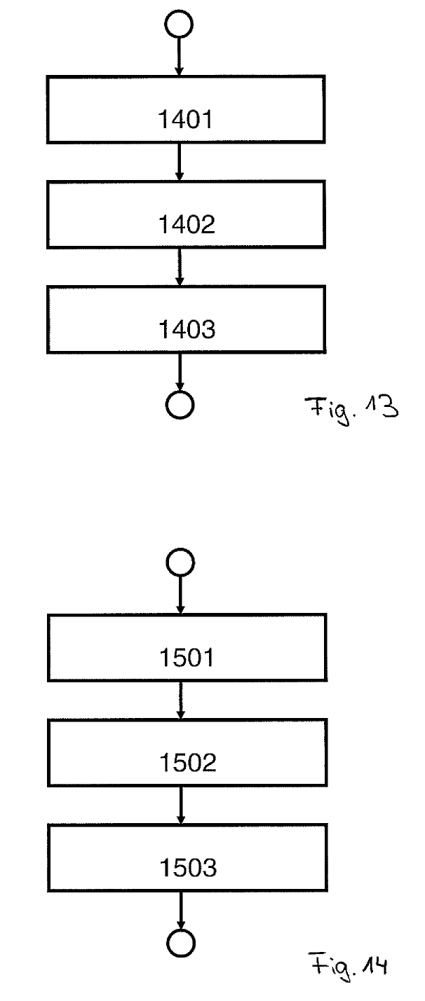

FIG. 13 illustrates a method according to an exemplary embodiment of the present invention. In FIG. 13 the method comprises in a step 1401 receiving a first message comprising a bearer management information for a session of a user. The method further comprises in a step 1402 selecting a first network device, wherein the selected first network device may be located in a down-stream direction 2 towards the user 10. The method of FIG. 13 further comprises in a step 1403 sending a second message comprising the bearer management information of the user to the selected network device.

FIG. 14 illustrates a method according to an exemplary embodiment of the present invention. The method of FIG. 14 comprises in a step 1501 receiving a first message comprising a bearer management information for a session of a user. Moreover, the method comprises in a step 1502 sending a second message comprising a response to the received bearer management information 1220 of the user to a network device located in an up-stream direction 1. The method of FIG. 14 further comprises in step 1503 routing traffic utilizing the received bearer management information. Routing traffic may comprise sending traffic to internet 250 without utilizing a path through the core network 140. Moreover, routing traffic may comprise receiving traffic from the internet 250 without utilizing a path through the core network 140.

Any functions, methods and operations described above may of course be implemented by way of software and/or hardware.

In general, it is to be noted that respective functional elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

The network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

For the purpose of the present invention as described herein above, it should be noted that:

an access technology via which signaling is transferred to and from a network element or node may be any technology by means of which a node can access an access network (e.g. via a base station or generally an access node). Any present or future technology, such as WLAN (Wireless Local Access Network), WiMAX (Worldwide Interoperability for Microwave Access), BlueTooth, Infrared, and the like may be used; although the above technologies are mostly wireless access technologies, e.g. in different radio spectra, access technology in the sense of the present invention implies also wirebound technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,

usable access networks may be any device, apparatus, unit or means by which a station, entity or other user equipment may connect to and/or utilize services offered by the access network; such services include, among others, data and/or (audio-) visual communication, data download etc.;

a user equipment may be any device, apparatus, unit or means by which a system user or subscriber may experience services from an access network, such as a mobile phone, personal digital assistant PDA, or computer;

method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;

generally, any method step is suitable to be implemented as software or by hardware without changing the idea of the invention in terms of the functionality implemented;

method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;

devices, apparatuses, units or means can be implemented as individual devices, apparatuses, units or means, but this does not exclude that they are implemented in a distributed fashion throughout the system, as long as the functionality of the device, apparatus, unit or means is preserved,

an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;

a device may be regarded as an apparatus or as an assembly of more than one apparatus, whether functionally in cooperation with each other or functionally independently of each other but in a same device housing, for example.

Although described above mainly with respect to methods, procedures, an apparatus and modules thereof, it is to be understood that the present invention also covers a computer program products for implementing such methods or procedures and/or for operating such apparatuses or modules, as well as computer-readable (storage) media for storing such computer program products. The present invention also covers any conceivable combination of method steps and operations described above, and any conceivable combination of nodes, apparatuses and modules described above, as long as the above-described concepts of methodology and structural arrangement are applicable.

Furthermore, the network devices or network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

In this context, “first”, “second”, “third”, etc. in relation to messages or network devices may not be understood as hierarchy, it should be understood only to distinguish different messages or different devices from each other. It should be noted, that arrows of messages in the figures may indicate the direction of message flow, for example indicating receiving or sending a message for a respective device.

The terms “data”, “content”, “information”, “parameter”, “message” and similar terms may be used interchangeably, according to some example embodiments of the present invention, to refer to data capable of being transmitted, received, operated on, and/or stored.

It should be noted that the term “comprising” does not exclude other elements or steps and the “a” or “an” does not exclude a plurality. Also elements described in association with different embodiments may be combined.

It should be noted, that reference signs in the claims shall not be construed as limiting the scope of the claims.

### LIST OF ABBREVIATIONS

3GPP=Third Generation Partnership Project
APN=Access Point Name
BOGW=Breakout Gateway
CG=Charging Gateway
CN=Core Network
DL=Downlink
DHCPv4=DHCPv4=Dynamic Host Configuration Protocol (version 4)
DHCP(v6)=DHCPv6=Dynamic Host Configuration Protocol (version 6)
ECM=Error Correction Mode
eNB=enhanced node B
EPS=Evolved Packet System
E-UTRAN=Evolved UTRAN=Evolved Universal Terrestrial Radio Access Network
GPRS=general packet radio service
GTP=GPRS Tunnelling Protocol
GW=gateway
GGSN=Gateway GPRS Support Node
HSPA=High Speed Packet Access
HeNB=Home eNodeB
HNB=Home NodeB
HNBGW=Home NodeB Gateway
IMSI=International Mobile Subscriber Identity
IP=Internet Protocol
IP(v6/v4)=Internet Protocol (version 6/version 4)
LAN=area network
LTE=Long-Term Evolution
LIG=Lawful Interception Gateway
LIPA=Local IP Access
L-GW=Local Breakout Gateway
MME=Mobility Management Entity
NB=NodeB
PPP=point-to-point protocol
PDN=Packet Data Network
PDN GW/P-GW=Packet Data Network Gateway
PDP=Packet Data Protocol
PGW=Packet Data Gateway
QoS=Quality of Service
RAN=Radio Access Network
RNC=Radio Network Controller
RNC Id=Radio Network Controller Identity
SGSN=Serving GPRS Support Node
SIPTO=Selected IP Traffic Offload
S-GW=Serving Gateway
TEID=Transport Endpoint Identifier
UE=User Equipment
UL=Uplink
VAS=Value Added Services

1. Method comprising:
receiving a first message comprising a bearer management information for a session of a user;
selecting a first network device wherein the selected first network device is located in a down-stream direction towards the user; and
sending a second message comprising the bearer management information to the selected network device.

2. Method according to claim 1, further comprising
sending a third message comprising the bearer management information to a second network device, wherein the second network device is located in an up-stream direction of the user.

3. Method according to claim 1, wherein the bearer management information is at least one of the group of information consisting of a bearer creation information, bearer modification information, bearer deletion information and an accounting information.

4. Method according to claim 1, the method further comprises
providing a selection information for selecting a network device.

5. Method according to claim 1, the method further comprises
receiving the bearer management information from a network device located in a down-stream direction towards the user.

6. Method according to claim 1,
wherein the first message is at least one of the group of messages consisting of an update message, a modification message, a setup message, an activation message, a deactivation message, a delete message and a relocation message.

7. Method according to claim 1,
wherein the second message comprises a GTP signaling or a Radius signaling or a Diameter signaling.

8. Method according to claim 1, wherein
the second message comprises an address of the selected network device.

9. Method comprising:
receiving a first message comprising a bearer management information for a session of a user;
sending a second message to a network device located in an up-stream direction; and
routing traffic utilizing the received bearer management information.

10. Method according to claim 9, wherein the second message comprises at least one information selected from the group of information consisting of a bearer creation information, a bearer modification information, a bearer deletion information, a user information, a user equipment information and an accounting information.

11. Network device comprising
a receiving unit for receiving a first message comprising a bearer management information for a session of a user;
a sending unit for sending a second message to a first network device located in a down-stream direction.

12. Network device according to claim 11, wherein
the network device is a support node.

13. Network device according to claim 11, wherein
the network device is located in a core network.

14. Network device comprising:
a receiving unit for receiving a first message comprising a bearer management information for a session of a user;
a sending unit for sending a second message to a network device located in an up-stream direction;
a routing unit for routing traffic utilizing the received bearer management information.

15. Network device according to claim 14, wherein the network device
comprises a traffic offload function.

16. Communication system comprising:
a first network device including a receiving unit for receiving a first message comprising a bearer management information for a session of a user;
a sending unit for sending a second message to a first network device located in a down-stream direction and a second network device according to claim 14.

17. Computer program product comprising code portions for causing a network device, on which the computer program is executed, to carry out a method according to claim 1.

18. Computer-readable medium embodying the computer program product according to claim 17.
